(19) United States
(12) Patent Application Publication
(10) Pub. No.: US 2025/0120352 A1
(43) Pub. Date: Apr. 17, 2025

(54) MULTITUBE POLYPIPE

(71) Applicants: Ashley L. Long, Forrest City, AR (US); James Brewer Blessitt, Hernando, MS (US)

(72) Inventors: Ashley L. Long, Forrest City, AR (US); James Brewer Blessitt, Hernando, MS (US)

(21) Appl. No.: 18/380,057

(22) Filed: Oct. 13, 2023

(51) Int. Cl. A01G 25/02; F16L 11/22

(52) U.S. Cl. CPC A01G 25/02; F16L 11/22

(57) ABSTRACT

An irrigation device includes a first collapsible tube. The first collapsible tube includes a first tubular wall configured in size and shape to carry water in sufficient quantity to provide water for irrigation of commercial agriculture crop cultivation. The irrigation device further includes a second collapsible tube fixedly coupled longitudinally to the first collapsible tube. The second collapsible tube includes a second tubular wall configured in size and shape to carry water in sufficient quantity to provide water for irrigation of commercial agriculture crop cultivation.

### BACKGROUND

### Background and Relevant Art

Agricultural crop cultivation is an essential activity for the preservation of human and domesticated animal life. Modern cultivation techniques, including fertilizers, genetic modification, pesticides, large machinery, and the like have enabled tremendous yields per plot of land.

One challenge in agricultural crop cultivation that has universally persisted is having reliable and sufficient irrigation. Without sufficient water, crops simply cannot be grown in large quantities. Inconsistency of natural irrigation sources, such as rain and humidity, has necessitated manual intervention where irrigation water is provided using various artificial vessels and channels, whether that be from hand watering using a watering can; to earthen ditches with their various culverts, manual openings, syphon tubes, and the like; to hand, wheel, and/or pivot aluminum piping, etc.

One method of artificial irrigation involves the use of so-called “polypipe”. There are at least two different types of polypipe in common usage, one for smaller home scale crop growth and home and commercial ornamental plant growth and a second type having size and water carrying capacity for commercial level agricultural crop irrigation. The first type is formed of a rigid configuration of polyethylene tubing being of small diameter (with a circular cross sectional area), such as about ¼ inch or less. The second type is formed of a flexible configuration of polyethylene tubing having a much larger cross sectional area than the first type, such as about 20 in², 38 in², 64 in², 79 in², or 113 in². When used herein, polypipe refers to the second type.

Polypipe is typically provided by vendors on large rolls, such as approximately 500 to 1,320 linear feet per roll. Polypipe irrigation is deployed in an agricultural field by unrolling the polypipe from an unspooling bracket deployed on a tractor. Generally, the tractor will drive through a field, typically at a topographically high point of the field, while the polypipe is unrolled from the unspooling bracket. Crops are destroyed where the wheels of the tractor travel and no crops can be grown directly under the deployed polypipe.

Once the polypipe is deployed in the field, a terminal end of the polypipe is closed off, such as by tying a knot in the polypipe or folding the polypipe and weighting the end. Next, water is run through the polypipe to fill the polypipe and cause it to distend with water. A farm worker then pierces the polypipe at various locations to allow irrigation water to be applied to the field. Typically, the farm worker will pierce the polypipe in locations corresponding to furrows in the field, where a furrow is a small ditch between rows of crops. There are several challenges with this type of irrigation. One challenge relates to overwatering crops, resulting in nitrogen leaching and denitrification whereby nitrogen fertilizers are essentially leached/denitrified away due to excessive irrigation. Farm workers combat this by only piercing the polypipe in locations corresponding to every other furrow. Thus, the amount of irrigation water for a given row of crops is reduced by about half, as it is watered by only one furrow. However, this causes unusual and undesirable growth patterns as the crops are only watered from one side of the crops.

A second challenge that occurs with polypipe water is related to pressure decreasing along the polypipe. In particular, pressure of water from the polypipe will be higher at an end where water is input into polypipe than at a terminal end of the polypipe, with the pressure gradually decreasing from where the water is input to the terminal end of the polypipe.

Yet another challenge that occurs with polypipe is related to sealing effects of silt loam soils that occurs with frequent furrow irrigation. In particular, certain types of soil can be exposed to so called “surface sealing” which occurs when a barrier is created on the surface of the soil due to excessive irrigation causing the soil to develop a crust as the soil dries where the crust resists water absorption.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes an irrigation device comprising a first collapsible tube. The first collapsible tube includes a first tubular wall configured in size and shape to carry water in sufficient quantity to provide water for irrigation of commercial agriculture crop cultivation. The irrigation device further includes a second collapsible tube fixedly coupled longitudinally to the first collapsible tube. The second collapsible tube includes a second tubular wall configured in size and shape to carry water in sufficient quantity to provide water for irrigation of commercial agriculture crop cultivation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a side view of a portion of an irrigation device with two collapsible tubes coupled to each other in a collapsed state;

FIG. 2 illustrates a side view and a cross sectional front view of a portion of an irrigation device with two collapsible tubes coupled to each other with one tube in a collapsed state, and another tube in a distended state;

FIG. 3 illustrates a cross sectional front view of a portion of an irrigation device with two collapsible tubes coupled to each other with one tube in a collapsed state, and another tube in a distended state;

FIG. 4 illustrates a cross sectional front view of a portion of an irrigation device with two collapsible tubes coupled to each other with one tube in a collapsed state, and another tube in a distended state;

FIG. 5 illustrates a cross sectional front view of a portion of an irrigation device with two collapsible tubes coupled to each other with one tube in a collapsed state, and another tube in a distended state;

FIG. 6 illustrates a side view of a portion of an irrigation device with two collapsible tubes coupled to each other and where each tube is configured to irrigate different furrows in a field;

FIG. 7 illustrates a side view of a portion of an irrigation device with two collapsible tubes coupled to each other and where each tube is configured to irrigate different furrows in a field;

FIG. 8 illustrates a side view of a portion of an irrigation device with more than two collapsible tubes coupled to each other;

FIG. 9 illustrates a side view of a portion of an irrigation device with two collapsible tubes coupled to each other; where one of the tubes is coupled, via a coupler to another collapsible tube;

FIG. 10 illustrates an irrigation device with a continuous connection point that is sufficiently wide to allow all or a portion of the connection point to be split;

FIG. 11 illustrates an irrigation device with a continuous, perforated connection point where the perforations facilitate all or a portion of the connection point being split;

FIG. 12 illustrates an irrigation device in a configuration for deployment of the irrigation device in a fashion where tubes are deployed in a stacked relationship; and

FIG. 13 illustrates an irrigation device in a configuration for deployment of the irrigation device in a fashion where tubes are deployed in a side-by-side relationship.

### DETAILED DESCRIPTION

Embodiments illustrated herein are directed to irrigation devices comprising a plurality of collapsible tubes coupled together. The collapsible tubes may be, for example, polypipe tubes. In particular, the collapsible tubes may be constructed of polyethylene, other woven materials, or combinations thereof.

The collapsible tubes are configured in size and shape to carry water in sufficient quantity to provide water for irrigation for commercial agricultural crop cultivation. For example, in some embodiments, the collapsible tubes may be configured to supply more than 2,000 gallons of water per minute. The collapsible tubes may have, for example, an outer dimension of about 16 inches, 22 inches, 28 inches, 31 inches, or 38 inches around the collapsible tubes. The collapsible tubes may have a facial area of 20 in², 38 in², 64 in², 79 in², or 113 in² when the collapsible tubes are carrying water.

The collapsible tubes are coupled to each other along the lengths of the collapsible tubes. This coupling may be for example, via polymer welding. Alternatively, this coupling may be via specialized construction of the irrigation device when the polypipe tubes are being manufactured. Alternatively, this coupling may be via adhesive. In some embodiments, the adhesive may be water resistant, while in other embodiments the adhesive is intentionally water soluble.

In some embodiments, selectively attachable adhesives may be used such that once the collapsible tubes are deployed in an agricultural field, the collapsible tubes can be disconnected without damaging the collapsible tubes. For example, in some embodiments, a water soluble adhesive may be used to connect the collapsible tubes, allowing for the collapsible tubes to be separated simply by exposing them to water. Alternatively, the collapsible tubes may be coupled by light or heat sensitive adhesives, that when exposed to light and/or heat causes the tubes to be separated.

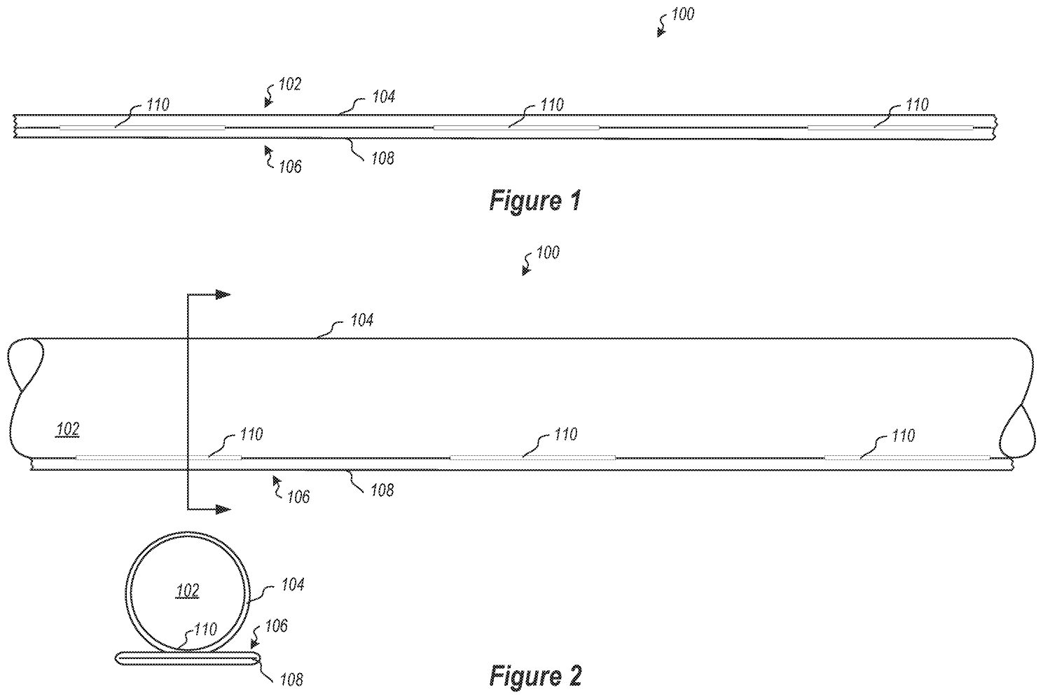

Referring now to FIGS. 1 and 2, an illustrated embodiment is shown. FIG. 1 illustrates side view of a portion of a first collapsible tube 102 in a collapsed state. The first collapsible tube 102 includes a first tubular wall 104 configured in size and shape to carry water in sufficient quantity to provide water for irrigation of commercial agriculture crop cultivation. The first tubular wall 104 may be, for example, 6 mil, 7 mil, or 10 mil thick. Some embodiments may implement tubular walls in a range of 4-12 mil thick, or even thicker.

FIG. 1 further illustrates a side view of a portion of a second collapsible tube 106 fixedly coupled longitudinally, along a second tubular wall 108, at connection points 110 to the first collapsible tube 102, along the first tubular wall 104. The second collapsible tube 106 includes the second tubular wall 108 configured in size and shape to carry water in sufficient quantity to provide water for irrigation of commercial agriculture crop cultivation. The second tubular wall 108 may be, for example, 6 mil, 7 mil, or 10 mil thick.

In some embodiments, the first and second collapsible tubes 102 and 106 are formed of polyethylene. That is the tubular walls 104 and 108 are formed of polyethylene.

The connection points 110 connecting first and second collapsible tubes 102 and 106 may be implemented in a number of different fashions. In some embodiments, the first and second collapsible tubes 102 and 106 are coupled along the entire lengths of the first and second collapsible tubes 102 and 106. In other embodiments, the first and second collapsible tubes 102 and 106 are coupled along intermittent lengths of the first and second collapsible tubes 102 and 106. For example, the connection points may be evenly spaced along approximately 50% of the lengths of the first and second collapsible tubes 102 and 106. In some such embodiments, the connection points 110 may have an equal amount of space between the connection points 110. In other embodiments, the connection points may be evenly spaced along the lengths of the first and second collapsible tubes 102 and 106.

By connecting the first and second collapsible tubes 102 and 106, deployment of the collapsible tubes together in a field is improved. In particular, previously, to deploy two collapsible tubes, a tractor may need to be driven at two different points in the field destroying significant amounts of crops. Alternatively, a precision deployment of a second collapsible tube might be needed to prevent disturbing a first, already deployed tube. Referring now to FIGS. 12 and 13, two different deployment configurations are shown.

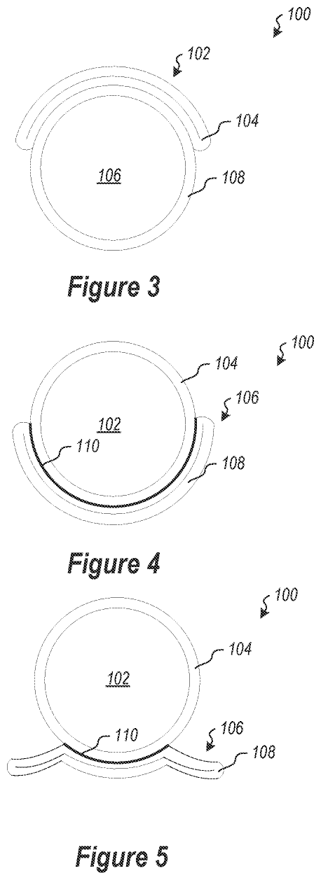

In the example shown in FIG. 12, the irrigation device 100 is in a configuration for deployment of the irrigation device 100 in a fashion where tubes are deployed in a stacked relationship. In particular, the first collapsible tube 102 is on top of the second collapsible tube 106, with one or more connection points 110 between the first collapsible tube 102 and the second collapsible tube 106. This allows for a deployed configuration such as that shown in FIGS. 3, 4, and 5 discussed in more detail below. Further, by stacking as shown, existing deployment equipment (e.g., tractors and unspooling brackets) can be used for deployment of the improved irrigation device 100. Thus, some embodiments may include providing the irrigation device 100 on a spool configured for stacked deployment.

In the example shown in FIG. 13, the irrigation device 100 is in a configuration for deployment of the irrigation device in a fashion where tubes are deployed in a side-by-side relationship. In particular, the first collapsible tube 102 is side-by-side the second collapsible tube 106, with one or more connection points 110 between the first collapsible tube 102 and the second collapsible tube 106 when deployed. In this example, the first collapsible tube 102 and second collapsible tube 106 are folded in half, with the fold along the one or more connection points 110. By folding as shown, existing deployment equipment (e.g., tractors and unspooling brackets) can be used for deployment of the improved irrigation device 100. Thus, some embodiments may include providing the irrigation device 100 on a spool pre-folded for side-by-side deployment.

FIG. 2 illustrates a side view and a cross sectional front view of an example where the second collapsible tube 106 is in a collapsed state, while the first collapsible tube 102 is in a distended, water carrying state. In this example, the first collapsible tube 102 lies on top of the second collapsible tube 106. As noted above, in other embodiments, the collapsible tubes 102 and 106 may be deployed next to each other in a side-by-side configuration.

FIG. 3 illustrates a cross sectional front view of an example where the first collapsible tube 102 is in a collapsed state, while the second collapsible tube 106 is in a distended, water carrying state. In this example, the first collapsible tube 102 lies on top of the second collapsible tube 106.

The connection points 110 may occupy different total percentages of the first and second tubular walls. For example, FIG. 4 illustrates a cross sectional front view of an example where the collapsible tubes are coupled at about 50% of the total area of the tubular walls. FIG. 5 illustrates a cross sectional front view of an example where collapsible tubes are coupled at about 15% of the total area of the tubular walls. In some embodiments, the first and second collapsible tubes are fixedly coupled between 1 and 5% of the total area of the first and second tubular walls.

The irrigation device 100 may be implemented where outlet holes are formed in the collapsible tubes 102 and 106. Typically, these outlet holes are positioned corresponding to furrows between rows of crops. Often when polypipe tubes are used to water crops, one outlet hole will be formed in a single polypipe for each furrow. However, this has a number of drawbacks. One drawback is that the ends of the rows proximate the polypipe are watered at a significantly higher amounts than the ends of the rows distant the polypipe. This can result in deleterious and excessive nitrogen and other fertilizer leeching at the proximate ends of the rows as compared to the distant ends of the rows, with the leaching decreasing from the proximate ends of the rows to the distant ends of the rows. Some have combatted this by only watering in every other furrow. However, this creates unusual and unwanted growth patterns of the crops.

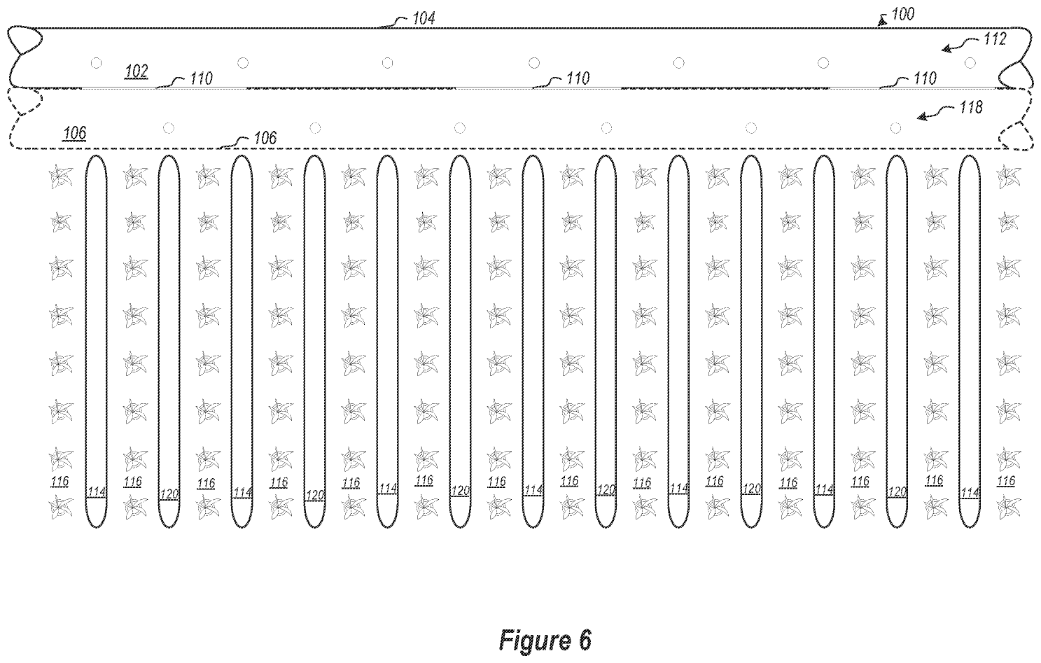

With reference now to FIG. 6, some embodiments illustrated here are able to address this challenge by implementing an irrigation device 100 where the first collapsible tube comprises first outlet holes 112 configured in size and shape to irrigate a first plurality of furrows 114 between rows of crops 116 and wherein the second collapsible tube comprises second outlet holes 118 configured in size and shape to irrigate a second plurality of furrows 120 between rows of crops 116 where the furrows in the second plurality of furrows 120 are interleaved between furrows in the first plurality of furrows 114. Typically, using this irrigation device 100, irrigation will be performed using the first collapsible tube 102 to provide water to the first plurality of furrows 114 while the second collapsible tube 106 remains idle in a collapsed state. Later, the second collapsible tube is used to water the second plurality of furrows 120, while the first collapsible tube remains idle in a collapsed state.

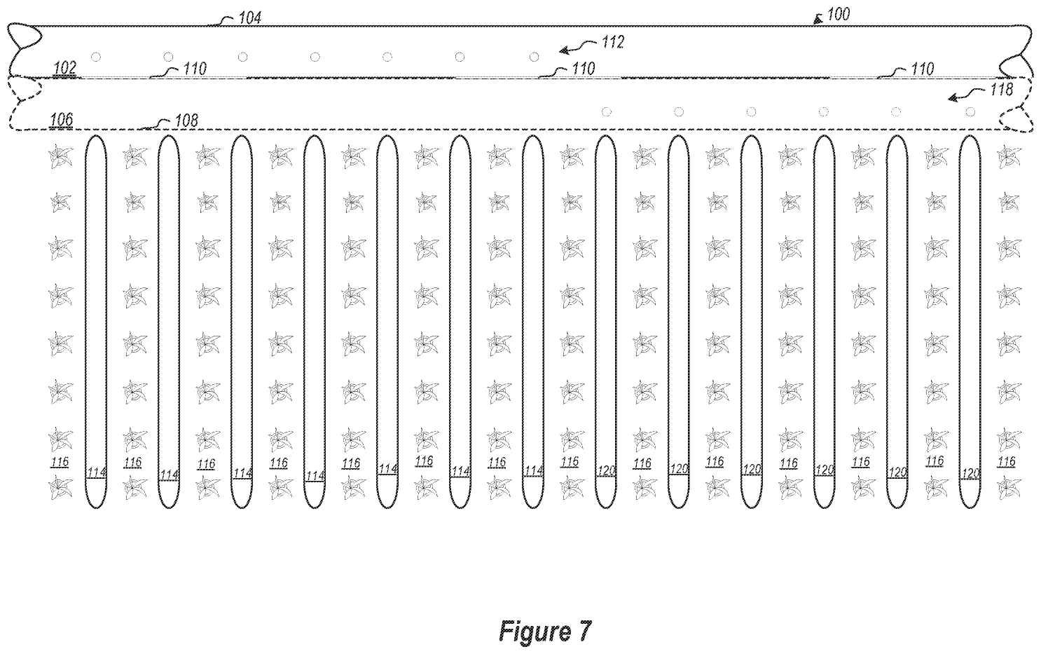

Another challenge that arises in using polypipe relates to the ability to get water with sufficient pressure to a distal end of a polypipe that is distant a water source providing water to the polypipe. In particular, as water is released out of outlet holes proximate the water source, pressure is reduced along the polypipe, resulting in less pressure available for distal outlet holes. Thus, it can be useful to implement a system with two different collapsible tubes where one of the collapsible tubes irrigates first furrows proximate the water source while another collapsible tube irrigates furrows more distant from the water source than the first furrows. With reference to FIG. 7, the irrigation device 100 may be implemented where the first collapsible tube 102 comprises first outlet holes 112 configured in size and shape to irrigate a first plurality of furrows 114, and wherein the second collapsible tube 106 comprises second outlet holes 118 configured in size and shape to irrigate a second plurality of furrows 120, the second plurality of furrows 120 being longitudinally distant the first plurality of furrows 114. The second collapsible tube 106 is configured to be prevented from irrigating along a majority portion corresponding to the first outlet holes. This is due to the second collapsible tube 106 having few (as compared to the first collapsible tube) if any outlet holes in the same location as the first outlet holes 112.

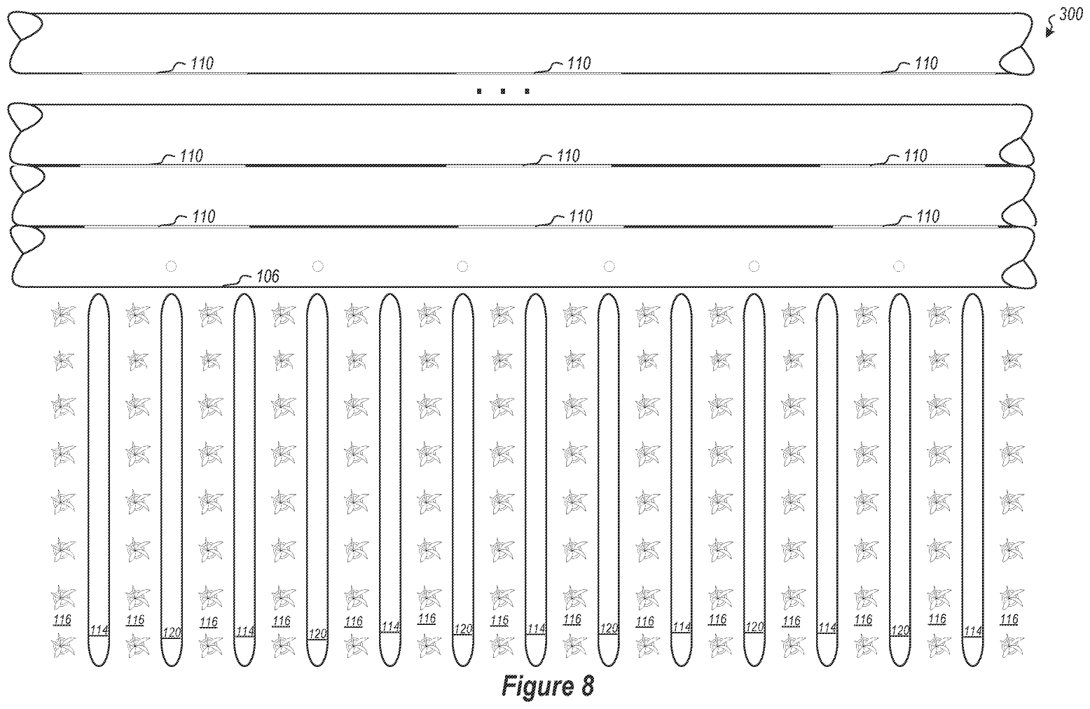

Note that while embodiments illustrated herein have shown two collapsible tubes coupled together, it should be appreciated that embodiments of the irrigation device may be implemented with 3 or more collapsible tubes in other configurations. This is represented by the irrigation device 300 illustrated in FIG. 8. While any feasible number of collapsible tubes can be implemented with connection points 110 between the collapsible tubes, embodiments having between 2 and 5 collapsible tubes are contemplated in various embodiments.

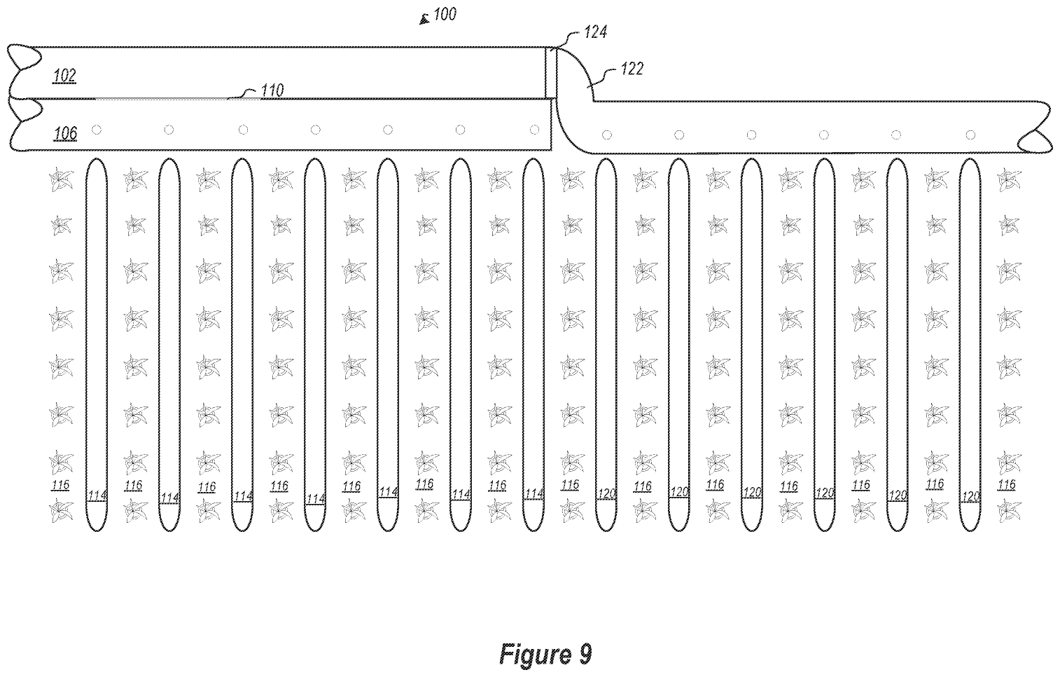

Note that embodiments may be implemented where one or more of the interconnected collapsible tubes may be coupled to via a coupler to another collapsible tube. An example of this is illustrated in FIG. 9, which illustrates the irrigation device 100 where the first collapsible tube 102 is coupled to a conventional collapsible tube 122 via a coupler 124. This is facilitated by the intermittent connection points 110 along the irrigation device 100, In particular, by having portions of the two collapsible tube that are not connected by connection points, the first collapsible tube can be coupled at a proximate end of the coupler 124 while the second collapsible tube 122 is coupled at a distal end of the coupler 124. In particular, the coupler 124 typically includes an inner portion that fits inside of the collapsible tubes 102 and 122 and an outer band that secures the collapsible tubes 102 and 122 by a pressure fit to the inner portion. If the irrigation device 100 were coupled continuously along the entire lengths of first and second collapsible tubes 102 and 106, it would be difficult or impossible to use conventional polypipe couplers.

Note that embodiments may be implemented where all or portions of the collapsible tubes 102 and 106 may be separated from each other to allow for coupler installation or for other reasons. For example, as discussed above, the connection points 110 may be made with water soluble, heat sensitive, light sensitive, (or other characteristic) adhesives. The adhesives may facilitate separating all or portions of the collapsible tubes 102.

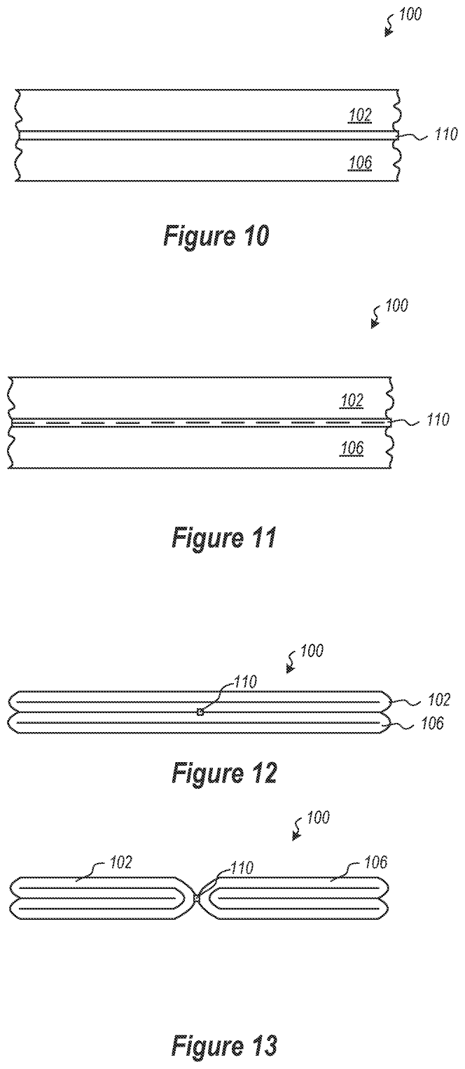

Another configuration of the irrigation device 100 is illustrated in FIG. 10. In this example, a single connection point 110 runs the entire length of the irrigation device 100. However, the connection point 110 is of sufficient size and strength to allow for cutting the irrigation device 100 at the connection point to allow the irrigation device to have a portion along the cut where the collapsible tube 102 is separated from the collapsible tube 106. This can be done to allow for couplers to be installed, to allow for routing portions of the collapsible tubes away from each other, or for other reasons.

One configuration illustrated in FIG. 11 illustrates that the single continuous connection point 110 can be perforated to allow for guided cutting or tearing apart of the collapsible tubes 102 and 106.

Note that the collapsible tubes of the various irrigation devices may be coupled to each other in a number of different fashions. For example, as discussed above, the collapsible tubes may be coupled via connection points formed using various adhesives.

Alternatively or additionally, the collapsible tubes may be coupled via connection points formed using various polymer or other welding techniques.

Alternatively or additionally, the collapsible tubes may be coupled via connection points formed by splitting a collapsible tube into two new collapsible tubes. For example, a collapsible tube with an outer dimension of about 38 inches around the collapsible tube may be polymer welded in the middle of the collapsible tube to form an irrigation device with two collapsible tubes, each about 19 inches around, coupled continuously to each other via a connection point formed during the welding process.

Alternatively or additionally, the collapsible tubes may be coupled via connection points formed by during manufacture of the collapsible tubes themselves such that the collapsible tubes are formed already having one or more connection points between them.

Note that the collapsible tubes are typically constructed such that fluid flowing in the collapsible tubes does not intermingle between the collapsible tube absent specific actions taken to couple inlets or outlets of the collapsible tubes together. That being said, embodiments may be implemented where the collapsible tubes are manufactured having holes along the tubes which allows for intermingling of fluids between the collapsible tubes. Alternatively or additionally, in some embodiments, holes can be later added along certain connection points to allow fluid to intermingle between the collapsible tubes.

Note that while the examples illustrated here have shown the collapsible tubes in an irrigation device to be of approximate the same outer dimension size, it should be appreciated that in other embodiments, different sized collapsible tubes may be interconnected. For example, a collapsible tube with an outer dimension of about 16 inches may be coupled to a collapsible tube with an outer dimension of about 31 inches.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

A method of irrigating is now disclosed. The method includes deploying an irrigation device in a commercial agricultural field. The irrigation device includes a first collapsible tube. The first collapsible tube includes a first tubular wall configured in size and shape to carry water in sufficient quantity to provide water for irrigation of commercial agriculture crop cultivation. The irrigation device further includes a second collapsible tube fixedly coupled longitudinally to the first collapsible tube. The second collapsible tube includes a second tubular wall configured in size and shape to carry water in sufficient quantity to provide water for irrigation of commercial agriculture crop cultivation. The first collapsible tube is caused to have outlet holes configured in size and shape to irrigate a first plurality of furrows. The second collapsible tube is caused to have outlet holes configured in size and shape to irrigate a second plurality of furrows. The method further includes causing first irrigation water to flow in the first collapsible tube to cause irrigation of the first plurality of furrows. The method further includes causing second irrigation water to flow in the first collapsible tube to cause irrigation of the second plurality of furrows.

The method may further include forming the first outlet holes and the second outlet holes so that the first outlet holed are configured to irrigate furrows interleaved with the second outlet holes.

The method may further include forming the first outlet holes and the second outlet holes so that the second plurality of furrows are longitudinally distant the first plurality of furrows. The second collapsible tube is configured to be prevented from irrigating along a major portion corresponding to the first outlet holes.

Another method includes acts for making an irrigation device. The method includes forming a first collapsible tube. The first collapsible tube includes a first tubular wall configured in size and shape to carry water in sufficient quantity to provide water for irrigation of commercial agriculture crop cultivation. The method further includes forming a second collapsible tube. The second collapsible tube includes a second tubular wall configured in size and shape to carry water in sufficient quantity to provide water for irrigation of commercial agriculture crop cultivation. The method further includes causing the first collapsible tube to be fixedly coupled longitudinally to the second collapsible tube.

The method of making an irrigation device may be practiced where causing the first collapsible tube to be fixedly coupled longitudinally to the second collapsible tube includes coupling the first collapsible tube to the second collapsible tube using adhesive.

The method of making an irrigation device may be practiced where causing the first collapsible tube to be fixedly coupled longitudinally to the second collapsible tube includes coupling the first collapsible tube to the second collapsible tube using polymer welding.

The method of making an irrigation device may be practiced where causing the first collapsible tube to be fixedly coupled longitudinally to the second collapsible tube includes splitting an original collapsible tube into a plurality of collapsible tubes via a welding process between the tubes in the plurality of collapsible tubes.

The method of making an irrigation device may be practiced where causing the first collapsible tube to be fixedly coupled longitudinally to the second collapsible tube includes forming the first collapsible tube and the second collapsible tube to be interconnected during a manufacturing process for manufacturing the first collapsible tube and the second collapsible tube.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An irrigation device comprising:
a first collapsible tube, the first collapsible tube comprising a first tubular wall configured in size and shape to carry water in sufficient quantity to provide water for irrigation of commercial agriculture crop cultivation; and
a second collapsible tube fixedly coupled longitudinally to the first collapsible tube, the second collapsible tube comprising a second tubular wall configured in size and shape to carry water in sufficient quantity to provide water for irrigation of commercial agriculture crop cultivation.

2. The irrigation device of claim 1, wherein the first and second collapsible tubes are formed of polyethylene.

3. The irrigation device of claim 1, wherein the first and second collapsible tubes are formed of a mesh material.

4. The irrigation device of claim 1, wherein the first and second collapsible tubes are fixedly coupled between 1 and 5% of the area of the first and second tubular walls.

5. The irrigation device of claim 1, wherein the first and second collapsible tubes are fixedly coupled at or less than 50% of the area of the first and second tubular walls.

6. The irrigation device of claim 1, wherein the first collapsible tube comprises first outlet holes configured in size and shape to irrigate a first plurality of furrows, and wherein the second collapsible tube comprises second outlet holes configured in size and shape to irrigate a second plurality of furrows, the furrows in the second plurality of furrows being interleaved between furrows in the first plurality of furrows.

7. The irrigation device of claim 1, wherein the first collapsible tube comprises first outlet holes configured in size and shape to irrigate a first plurality of furrows, and wherein the second collapsible tube comprises second outlet holes configured in size and shape to irrigate a second plurality of furrows, the second plurality of furrows being longitudinally distant the first plurality of furrows, the second collapsible tube being configured to be prevented from irrigating along a major portion corresponding to the first outlet holes.

8. The irrigation device of claim 1, wherein the first and second collapsible tubes are coupled together using adhesive.

9. The irrigation device of claim 1, wherein the first and second collapsible tubes are coupled together using polymer welding.

10. The irrigation device of claim 1, wherein the first and second collapsible tubes are coupled together at intermittent connection points.

11. The irrigation device of claim 1, wherein the first and second collapsible tubes are coupled together continuously along the first tubular wall and the second tubular wall.

12. The irrigation device of claim 1, wherein the first and second collapsible tubes are coupled together using a perforated connection point.

13. A method of irrigating comprising:
Deploying an irrigation device in a commercial agricultural field, the irrigation device comprising:
a first collapsible tube, the first collapsible tube comprising a first tubular wall configured in size and shape to carry water in sufficient quantity to provide water for irrigation of commercial agriculture crop cultivation; and
a second collapsible tube fixedly coupled longitudinally to the first collapsible tube, the second collapsible tube comprising a second tubular wall configured in size and shape to carry water in sufficient quantity to provide water for irrigation of commercial agriculture crop cultivation;
wherein the first collapsible tube is caused to have first outlet holes configured in size and shape to irrigate a first plurality of furrows, and wherein the second collapsible tube is caused to have second outlet holes configured in size and shape to irrigate a second plurality of furrows;
causing first irrigation water to flow in the first collapsible tube to cause irrigation of the first plurality of furrows; and
causing second irrigation water to flow in the first collapsible tube to cause irrigation of the second plurality of furrows.

14. The method of claim 13, further comprising forming the first outlet holes and the second outlet holes so that the first outlet holes are configured to irrigate furrows interleaved with the second outlet holes.

15. The method of claim 13, further comprising forming the first outlet holes and the second outlet holes so that the second plurality of furrows are longitudinally distant the first plurality of furrows, the second collapsible tube being configured to be prevented from irrigating along a major portion corresponding to the first outlet holes.

16. A method of making an irrigation device, the method comprising:
forming a first collapsible tube, the first collapsible tube comprising a first tubular wall configured in size and shape to carry water in sufficient quantity to provide water for irrigation of commercial agriculture crop cultivation;
forming a second collapsible tube, the second collapsible tube comprising a second tubular wall configured in size and shape to carry water in sufficient quantity to provide water for irrigation of commercial agriculture crop cultivation; and
causing the first collapsible tube to be fixedly coupled longitudinally to the second collapsible tube.

17. The method of making an irrigation device of claim 16, wherein causing the first collapsible tube to be fixedly coupled longitudinally to the second collapsible tube comprises coupling the first collapsible tube to the second collapsible tube using adhesive.

18. The method of making an irrigation device of claim 16, wherein causing the first collapsible tube to be fixedly coupled longitudinally to the second collapsible tube comprises coupling the first collapsible tube to the second collapsible tube using polymer welding.

19. The method of making an irrigation device of claim 16, wherein causing the first collapsible tube to be fixedly coupled longitudinally to the second collapsible tube comprises splitting an original collapsible tube into a plurality of collapsible tubes via a welding process between the tubes in the plurality of collapsible tubes.

20. The method of making an irrigation device of claim 16, wherein causing the first collapsible tube to be fixedly coupled longitudinally to the second collapsible tube comprises forming the first collapsible tube and the second collapsible tube to be interconnected during a manufacturing process for manufacturing the first collapsible tube and the second collapsible tube.
